(19) United States
(12) Patent Application Publication
(10) Pub. No.: US 2025/0153954 A1
(43) Pub. Date: May 15, 2025

(54) SYSTEMS FOR HANDLING GREEN CERAMIC MONOLITHS

(71) Applicant: CORNING INCORPORATED, CORNING, NY (US)

(72) Inventors: Kenneth Charles Driesbaugh, Elmira, NY (US); Kevin Eugene Elliott, Newton, NC (US); Justin Carl Fossum, Horseheads, NY (US); Robert John Locker, CORNING, NY (US)

(21) Appl. No.: 18/917,421

(22) Filed: Oct. 16, 2024

Related U.S. Application Data
(60) Provisional application No. 63/599,210, filed on Nov. 15, 2023.

(51) Int. Cl. B65G 47/24

(52) U.S. Cl. CPC B65G 47/24; B65G 2201/0258

(57) ABSTRACT

Disclosed herein is a system for handling green ceramic monoliths that includes a lifting apparatus including a body and at least two support prongs that extend from the body, the at least two support prongs configured to support a green ceramic monolith thereon. The system also includes a support tray that receives the green ceramic monolith from the lifting apparatus and includes a base, a plurality of ridges, and a plurality of grooves, wherein each of the plurality of grooves is spaced apart from an adjacent groove by one of the plurality of ridges. The system further includes an actuator coupled to the lifting apparatus, wherein the actuator is operable to manipulate the lifting apparatus to engage the support tray and thereby transfer support of the green ceramic monolith from the at least two support prongs of the lifting apparatus to the plurality of ridges.

### CROSS REFERENCE TO RELATED APPLICATION

This application claims the benefit of priority under 35 U.S.C. § 119 of U.S. Provisional Application Ser. No. 63/599,210 filed on Nov. 15, 2023, the content of which is relied upon and incorporated herein by reference in its entirety.

### TECHNICAL FIELD

The present specification generally relates to systems, methods, and apparatuses for handling or conveying green ceramic monoliths and, more specifically, systems, methods, and apparatuses for supporting green ceramic monoliths as the green ceramic monoliths undergo drying.

### BACKGROUND

Extrude-to-shape parts are generally manufactured by extruding a raw ceramic material to form a horizontally oriented extrusion and individual green ceramic parts are obtained by cutting off lengths of the extrusion. The parts then typically undergo additional processing, such as drying, in the horizontal orientation. However, horizontal processing can produce undesirable characteristics in the parts, such as shape distortion. In contrast, non-horizontal processing of parts can avoid such undesirable characteristics.

Accordingly, a need exists for improved systems, methods, and apparatuses for processing green ceramic parts, such a green ceramic monoliths, in various orientations as the green ceramic monoliths undergo processing.

### SUMMARY

A first aspect of the present disclosure may be directed to a system for handling green ceramic monoliths that includes a lifting apparatus including a body and at least two support prongs that extend from the body, each of the at least two support prongs including a prong length L_{P}, a prong width W_{P}, and a prong height H_{P}, the at least two support prongs configured to support a green ceramic monolith thereon, a support tray that receives the green ceramic monolith from the lifting apparatus, the support tray including: a base extending longitudinally between a first end and a second end and including an upper surface spaced apart from a lower surface, a plurality of ridges extending upward from the upper surface of the base, the plurality of ridges defining a support surface parallel to the upper surface of the base, and a plurality of grooves extending downward from the support surface to the upper surface of the base, each of the plurality of grooves including a groove length L_{G}, a groove width W_{G}, and a groove height H_{G}, wherein each of the plurality of grooves is spaced apart from an adjacent groove by one of the plurality of ridges, and an actuator coupled to the body of the lifting apparatus, wherein: the prong height H_{P} of each of the at least two support prongs is less than the groove height H_{G} of each of the plurality grooves, the prong width W_{P} of each of the at least two support prongs is less than the groove width W_{G} of each of the plurality grooves; and the actuator is operable to manipulate the body of the lifting apparatus to engage the at least two support prongs of the body with the plurality of grooves of the support tray and disengage the at least two support prongs of the body from the plurality of grooves of the support tray and thereby transfer support of the green ceramic monolith from the at least two support prongs of the body of the lifting apparatus to the support surface of the plurality of ridges.

A second aspect of the present disclosure may include the system of the first aspect, wherein the actuator is operable to at least one of: raise and lower the body of the lifting apparatus relative to the support tray; and pivot the body of the lifting apparatus relative to the support tray about an axis parallel to the support surface of the plurality of ridges.

A third aspect of the present disclosure may include the system of any preceding aspect, wherein the support tray includes a plurality of through-holes that extend through each of the plurality of ridges from the support surface to the lower surface of the base.

A fourth aspect of the present disclosure may include the system of any preceding aspect, wherein the support tray includes a plurality of through-holes that extend through the base from the upper surface to the lower surface in each of the plurality of grooves.

A fifth aspect of the present disclosure may include the system of any preceding aspect, wherein the support tray is formed from a ceramic material.

A sixth aspect of the present disclosure may include the system of any preceding aspect, wherein the plurality of ridges and the plurality of grooves extend across a width of the support tray and are oriented perpendicular to a longitudinal axis of the support tray.

A seventh aspect of the present disclosure may include the system of any preceding aspect, wherein the plurality of ridges and the plurality of grooves extend across a length of the support tray and are oriented parallel to a longitudinal axis of the support tray.

An eighth aspect of the present disclosure may include the system of any preceding aspect, wherein the support tray includes one or more protrusions that extend outward from sides of the base of the support tray.

A ninth aspect of the present disclosure may include the system of any preceding aspect, wherein the support tray comprises one or more notches formed in an outer sidewall of one of the plurality of ridges located adjacent to the first end or second end of the base; and a datum surface disposed in each of the one or more notches.

A tenth aspect of the present disclosure may be directed to a system for conveying a green ceramic monolith that includes a lifting apparatus including a body and a plurality of support prongs extending from the body, wherein the lifting apparatus is pivotable between a non-vertical configuration for receiving the green ceramic monolith in a non-vertical orientation and a vertical configuration for re-orienting the green ceramic monolith to a vertical orientation; a support tray for supporting the green ceramic monolith in the vertical orientation, the support tray including: a base extending longitudinally between a first end and a second end and comprising an upper surface spaced apart from a lower surface; a plurality of ridges disposed between the first end and the second end of the base and extending upward from the upper surface of the base, the plurality of ridges defining a support surface, each ridge of the plurality of ridges including a plurality of through-holes that extend between the support surface and the lower surface of the base; and a plurality of grooves disposed between the first end and the second end of the base and extending downward from the support surface to the upper surface of the base, each groove of the plurality of grooves including a plurality of through-holes extending between the upper surface and the lower surface of the base, wherein each groove of the plurality of grooves is adjacent to a ridge of the plurality of ridges, wherein, when the lifting apparatus is in the vertical configuration, the plurality of support prongs are received within the plurality of grooves of the support tray and positioned below the support surface of the plurality of ridges.

An eleventh aspect of the present disclosure may include the system of the tenth aspect, wherein the plurality of grooves of the support tray have a groove height H_{G} and the plurality of support prongs of the lifting apparatus have a prong height H_{P}, wherein the groove height H_{G} is greater than the prong height H_{P}.

A twelfth aspect of the present disclosure may include the system of the tenth through eleventh aspects, wherein the plurality of grooves of the support tray have a groove width W_{G} and the plurality of support prongs of the lifting apparatus have a prong width W_{P}, wherein the groove width W_{G} is greater than the prong width W_{P}.

A thirteenth aspect of the present disclosure may include the system of the tenth through twelfth aspects, further including a clearance of greater than or equal to 0.020″ (0.508 mm) to less than or equal to 0.040″ (1.016 mm) between each side of the plurality of support prongs and each side of the plurality of grooves when the lifting apparatus is in the vertical configuration and the plurality of support prongs are received within the plurality of grooves.

A fourteenth aspect of the present disclosure may include the system of the tenth through thirteenth aspects, further including a receiving cradle formed in the body of the lifting apparatus, the receiving cradle configured to receive the green ceramic monolith.

A fifteenth aspect of the present disclosure may include the system of the tenth through fourteenth aspects, wherein the plurality of ridges and the plurality of grooves extend across a width of the support tray and are oriented perpendicular to a longitudinal axis of the support tray.

A sixteenth aspect of the present disclosure may include the system of the tenth through fifteenth aspects, wherein the plurality of ridges and the plurality of grooves extend across a length of the support tray and are oriented parallel to a longitudinal axis of the support tray.

A seventeenth aspect of the present disclosure may be directed to a method for conveying a green ceramic monolith that includes receiving the green ceramic monolith on a lifting apparatus, the lifting apparatus including a body, at least two support prongs extending from the body, and an actuator coupled to the body, the at least two support prongs configured to support the green ceramic monolith thereon; aligning a support tray with the lifting apparatus, the support tray including a base, a plurality of ridges extending upward from the base to define a support surface, and a plurality of grooves, wherein each of the plurality of grooves is spaced apart from an adjacent groove by one of the plurality of ridges; engaging the at least two support prongs of the body of the lifting apparatus with the plurality of grooves of the support tray such that the green ceramic monolith is supported on the support surface of the support tray; and conveying the green ceramic monolith on the support tray for further processing.

An eighteenth aspect of the present disclosure may include the method of the seventeenth aspect, wherein the green ceramic monolith is received on the lifting apparatus in a non-vertical orientation; and the engaging comprises manipulating the body of the lifting apparatus with the actuator to reorient the green ceramic monolith from the non-vertical orientation to a vertical orientation.

A nineteenth aspect of the present disclosure may include the method of the seventeenth through eighteenth aspects, wherein the conveying disengages the at least two support prongs of the body of the lifting apparatus from the plurality of grooves of the support tray.

A twentieth aspect of the present disclosure may be directed to support tray for supporting a green ceramic monolith that includes a base extending longitudinally between a first end and a second end, the base including an upper surface spaced apart from a lower surface; a plurality of ridges disposed between the first end and the second end of the base and extending upward from the upper surface of the base, the plurality of ridges defining a support surface for supporting the green ceramic monolith, wherein each ridge in the plurality of ridges includes a plurality of through-holes extending between the support surface and the lower surface of the base; a plurality of grooves disposed between the first end and the second end of the base, the plurality of grooves extending downward from the support surface to the upper surface of the base, wherein each groove of the plurality of grooves is disposed adjacent to a ridge of the plurality of ridges; one or more notches formed in an outer sidewall of one of the plurality of ridges located adjacent to the first end or the second end of the base; and a datum surface disposed in each of the one or more notches.

A twenty-first aspect of the present disclosure may include the support tray of the twentieth aspect, wherein each groove of the plurality of grooves comprises a plurality of through-holes extending between the upper surface and the lower surface of the base.

A twenty-second aspect of the present disclosure may include the support tray of the twentieth through twenty-first aspects, wherein the plurality of ridges and the plurality of grooves extend across a width of the base and are oriented perpendicular to a longitudinal axis of the base.

A twenty-third aspect of the present disclosure may include the support tray of the twentieth through twenty-second aspects, wherein the plurality of ridges and the plurality of grooves extend across a length of the base and are oriented parallel to a longitudinal axis of the base.

A twenty-fourth aspect of the present disclosure may include the support tray of the twentieth through twenty-third aspects, wherein the plurality of grooves include: a first plurality of grooves extending across a width of the base and oriented perpendicular to a longitudinal axis of the base; and a second plurality of grooves extending across a length of the base and oriented parallel to a longitudinal axis of the base.

A twenty-fifth aspect of the present disclosure may include the support tray of the twentieth through twenty-fourth aspects, further including one or more protrusions extending outward from sides of the base.

A twenty-sixth aspect of the present disclosure may include the support tray of the twentieth through twenty-fifth aspects, wherein the support tray is formed from a ceramic fiber board.

A twenty-seventh aspect of the present disclosure may include the support tray of the twentieth through twenty-sixth aspects, wherein the support tray is formed from a fiberglass laminate.

A twenty-eighth aspect of the present disclosure may include the support tray of the twentieth through twenty-seventh aspects, wherein the support tray is formed from a porous material with a porosity greater than about 50% and an operating temperature of up to about 200° C.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a support tray that supports one or more green ceramic monoliths thereon, according to one or more embodiments shown and described herein;

FIG. 2 schematically depicts the support tray of FIG. 1 without the one or more green ceramic monoliths, according to one or more embodiments shown and described herein;

FIG. 3 schematically depicts adjacent support trays in a processing line, according to one or more embodiments shown and described herein;

FIG. 4 schematically depicts another support tray that supports one or more green ceramic monoliths thereon, according to one or more embodiments shown and described herein;

FIG. 5 schematically depicts an additional support tray that supports one or more green ceramic monoliths thereon, according to one or more embodiments shown and described herein;

FIG. 6A schematically depicts a system for orienting green ceramic monoliths from a horizontal orientation to a vertical orientation, according to one or more embodiments shown and described herein;

FIG. 6B schematically depicts a portion of the lifting apparatus of the system of FIG. 6A in a vertical configuration, according to one or more embodiments shown and described herein;

FIG. 6C schematically depicts a portion of the lifting apparatus of the system of FIG. 6A in a non-vertical configuration, according to one or more embodiments shown and described herein;

FIG. 7 schematically depicts the engagement between a lifting apparatus and a support tray of the system of FIG. 6, according to one or more embodiments shown and described herein; and

FIG. 8 schematically depicts a processing line which utilizes the system of FIG. 6A, according to one or more embodiments shown and described herein.

### DETAILED DESCRIPTION

Embodiments described herein are directed to systems, methods, and apparatuses for orienting and handling green ceramic monoliths. In embodiments, the systems, methods, and apparatus may be used to orient green ceramic monoliths from a non-vertical extrusion position to a vertical position to improve processing of the green ceramic monoliths during a drying process thereof. In embodiments, a system for handling green ceramic monoliths generally includes a lifting apparatus including a body and at least two support prongs that extend from the body. Each of the at least two support prongs includes a prong length L_{P}, a prong width W_{P}, and a prong height H_{P}, and the at least two support prongs are configured to support a green ceramic monolith thereon. The system further generally includes a support tray that receives the green ceramic monolith from the lifting apparatus, and the support tray includes: a base extending longitudinally between a first end and a second end and including an upper surface spaced apart from a lower surface, a plurality of ridges extending upward from the upper surface of the base, the plurality of ridges defining a support surface parallel to the upper surface of the base, and a plurality of grooves extending downward from the support surface to the upper surface of the base. Each of the plurality of grooves include a groove length L_{G}, a groove width W_{G}, and a groove height H_{G}, and each of the plurality of grooves is spaced apart from an adjacent groove by one of the plurality of ridges. The system additionally generally includes an actuator coupled to the body of the lifting apparatus. The prong height H_{P} of each of the at least two support prongs is less than the groove height H_{G} of each of the plurality of grooves, the prong width W_{P} of each of the at least two support prongs is less than the groove width W_{G} of each of the plurality of grooves, and the actuator is operable to manipulate the body of the lifting apparatus to engage the at least two support prongs of the body with the plurality of grooves of the support tray and disengage the at least two support prongs of the body from the plurality of grooves of the support tray and thereby transfer support of the green ceramic monolith from the at least two support prongs of the body of the lifting apparatus to the support surface of the plurality of ridges. Various embodiments of systems, methods, and apparatuses for handling green ceramic monoliths are described in further detail herein with specific reference to the appended drawings.

Various embodiments of the system for handling green ceramic monoliths and the operation of the method and support tray are described in more detail herein. Whenever possible, the same reference numerals will be used throughout the drawings to refer to the same or like parts.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

As previously discussed, extrude-to-shape parts, such as catalytic converter units and particulate filters, are generally manufactured by extruding a wet ceramic batch through a die to form a horizontal extrusion having a honeycomb structure. Individual units are obtained by cutting off lengths of the extrusion to form one or more green ceramic monoliths which subsequently undergo drying in a dryer and firing in a kiln. The green ceramic monoliths are typically processed in a horizontal orientation during drying and firing. However, horizontal processing of the green ceramic monoliths requires stiff batches of green ceramic product with low water content to help prevent distortion of the green ceramic monoliths in the horizontal orientation. This leads to high extrusion temperatures and, in turn, the creation of internal defects such as poor knitting of the walls of the cells of the honeycomb. Moreover, the industry has realized a need for extrude-to-shape parts with increased diameters and web thicknesses, adding weight to the green ceramic monoliths and increasing the likelihood of distortion when processing in the horizontal orientation. In contrast, vertical processing of green ceramic monoliths can permit larger extrude-to-shape diameters, less distortion to the shape of the green ceramic monoliths, and the use of green ceramic product with higher water content, which leads to lower extrusion temperatures that helps to improve knitting.

One path to vertical processing, which is the focus of the present disclosure, is the use of lifting, tipping, and/or pivoting to orient green ceramic monoliths to a vertical orientation after horizontal extrusion. Such an approach is advantageous as it permits the use of existing processing components such as extruders and dryers. When processing vertically, there is a need to transfer the green ceramic monoliths between various pieces of equipment such as from the extruder to a drying/support tray. To accomplish this, the present disclosure utilizes a tipping or lifting apparatus with support prongs that initially receives the green ceramic monoliths, lifts, tips, and/or pivots the green ceramic monoliths to the vertical orientation, and engages corresponding mating ridges and grooves on the support tray. The engagement of the support prongs with the mating ridges and grooves transfers support of the green ceramic monoliths in the vertical orientation from the lifting apparatus to the support tray for drying and further processing.

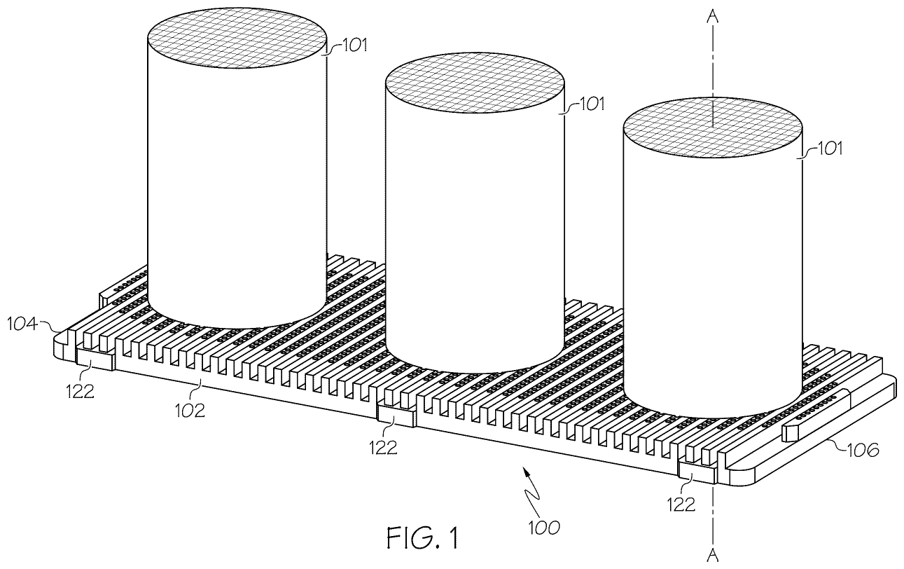

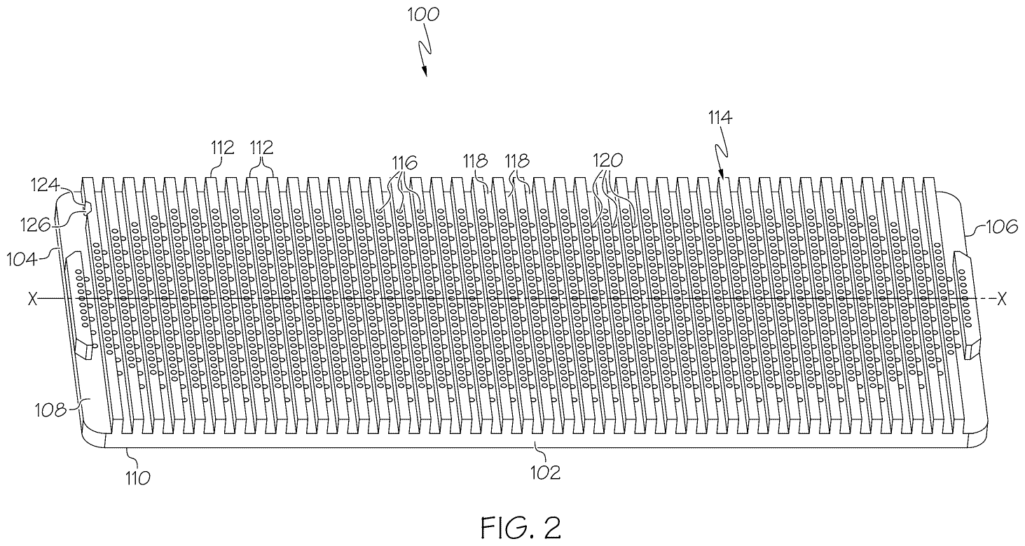

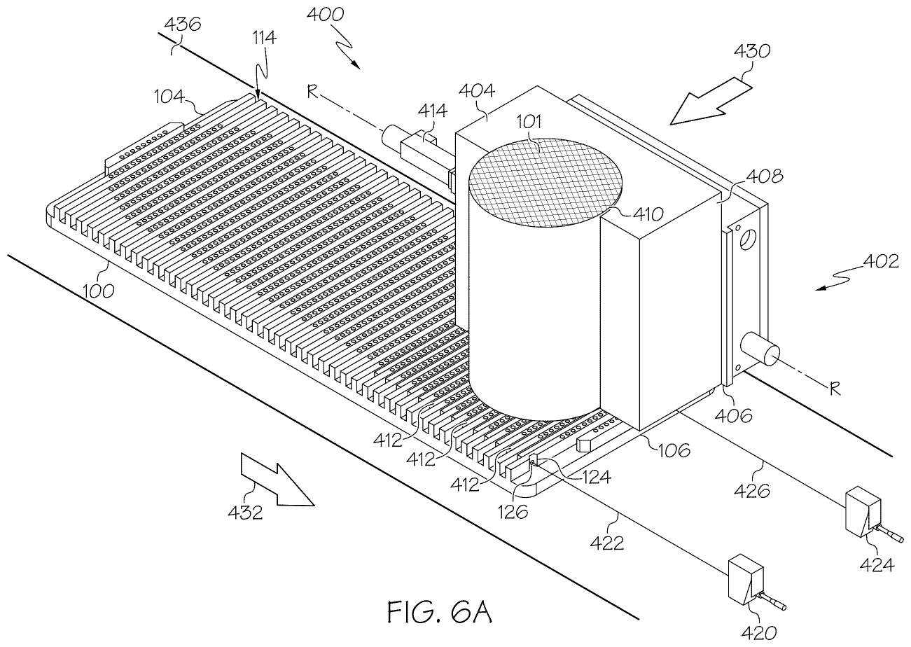

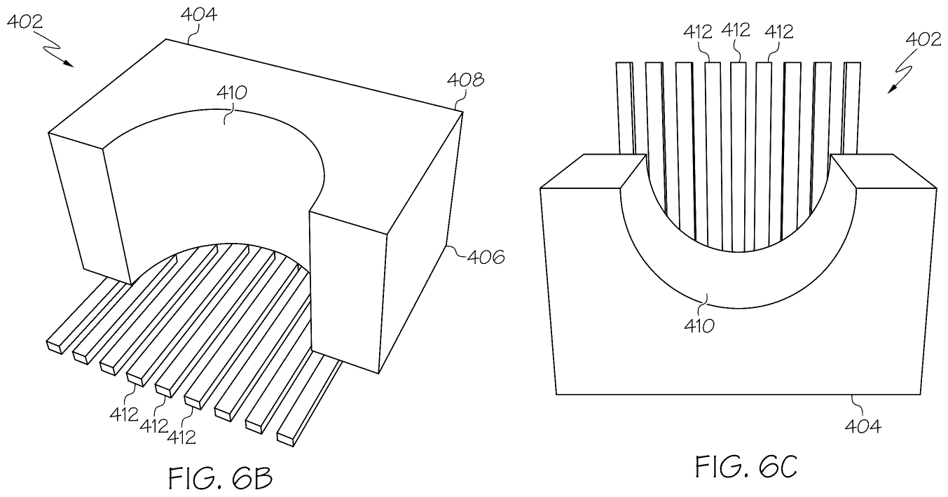

Referring now to FIGS. 1 and 2, a support tray 100 is illustrated according to one or more embodiments described herein. The support tray 100 is generally adapted to receive one or more green ceramic monoliths 101 from an associated lifting apparatus (e.g., lifting apparatus 402 shown in FIGS. 6A-6C and described in further detail herein). The associated lifting apparatus is generally adapted to re-orient the one or more green ceramic monoliths 101 from, for example, a non-vertical (e.g., horizontal) extrusion position to a vertical position. In addition, the support tray 100 is generally adapted to support each of the one or more green ceramic monoliths 101 as the one or more green ceramic monoliths 101 undergo a drying process. During the drying process, each of the one or more green ceramic monoliths 101 are supported vertically on the support tray 100 on vertical axis A-A to help minimize or prevent shape distortion around a periphery (e.g., a sidewall) of the one or more green ceramic monoliths 101 which would otherwise likely occur if the one or more green ceramic monoliths were supported in a non-vertical orientation.

The support tray 100 may generally include a base 102 that extends longitudinally along axis X-X (FIG. 2) between a first end 104 and a second end 106. The base 102 includes an upper surface 108 that is spaced apart from a lower surface 110. A plurality of ridges 112 extend upward from the upper surface 108 of the base 102 to define a support surface 114 that may be generally parallel to the upper surface 108. In other words, a top surface of the plurality of ridges 112 forms the support surface 114 that is spaced apart from the upper surface 108. The support surface 114 is generally configured to support the one or more green ceramic monoliths 101 thereon. A plurality of grooves 118 extend downward from the support surface 114 to the upper surface 108 of the base 102. Each of the plurality of grooves 118 is spaced apart from an adjacent groove by one of the plurality of ridges 112. In other words, each groove of the plurality of grooves 118 is adjacent to a ridge of the plurality of ridges 112. The plurality of grooves 118 provide an open area through which air can flow to aid the drying process of one or more green ceramic monoliths 101 disposed on the support surface 114. In some embodiments, the plurality of ridges 112 and the plurality of grooves 118 extend across a width or short-axis of the support tray 100 and are oriented perpendicular to the longitudinal axis X-X of the support tray 100. However, it should be understood that other orientations of the plurality of ridges 112 and the plurality of grooves 118 with respect to the longitudinal axis X-X of the support tray 100 are contemplated and possible.

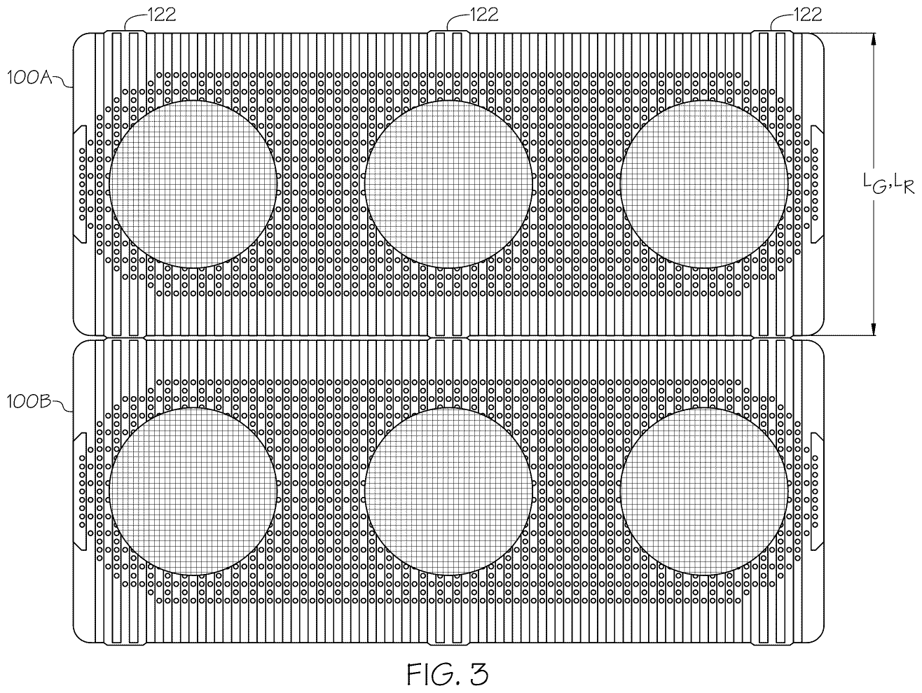

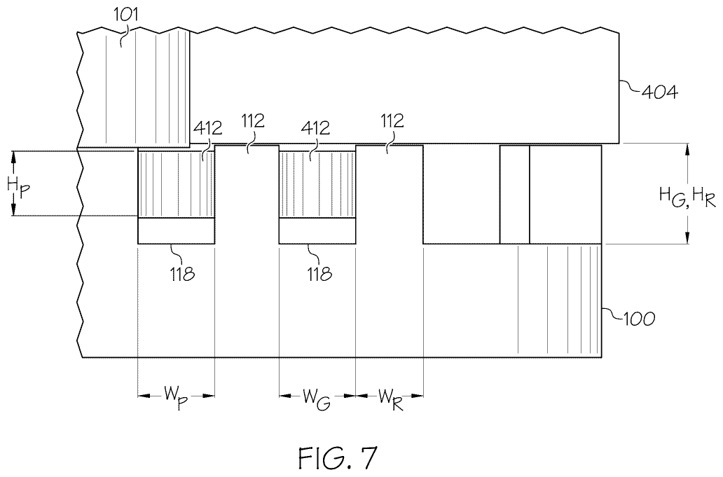

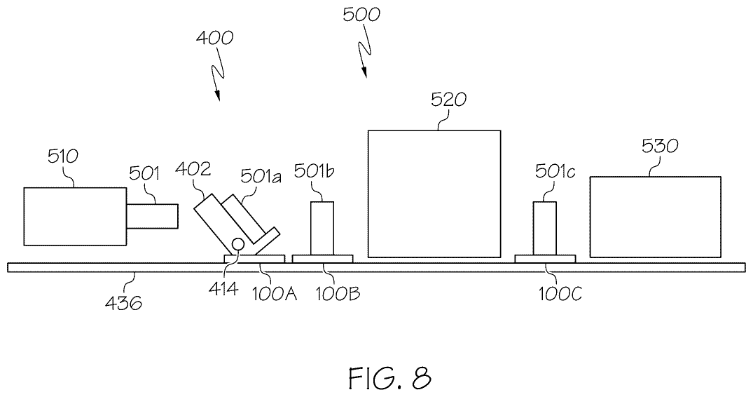

With reference to FIGS. 3 and 7, each of the plurality of ridges 112 has a ridge length L_{R}, a ridge width W_{R}, and a ridge height H_{R}. Moreover, each of the plurality of grooves 118 has a groove length L_{G}, a groove width W_{G}, and a groove height H_{G}. The ridge height H_{R} of each of the plurality of ridges 112 is generally equal to the groove height H_{G} of each of the plurality of grooves 118. In embodiments, the ridge length L_{R} of each of the plurality of ridges 112 and the groove length L_{G} of each of the plurality of grooves 118 are generally equal. However, in other embodiments, the ridge length L_{R} of some of the plurality of ridges 112 may be less than the groove length L_{G} of each groove of the plurality of grooves 118. For example, the ridges of the plurality of ridges 112 that are disposed adjacent the first end 104 and/or the second end 106 of the base 102 may have a ridge length L_{R} that is less than the other ridges in the plurality of ridges 112 and that is less than the groove length L_{G} of each groove of the plurality of grooves 118. Moreover, in embodiments, the ridge width W_{R} of each ridge of the plurality of ridges 112 is generally equal to the groove width W_{G} of each groove of the plurality of grooves 118. However, in other embodiments, the ridge width W_{R} of each ridge of the plurality of ridges 112 may be greater than or less than the groove width W_{G} of each groove of the plurality of grooves 118.

In some embodiments, the support tray 100 includes a plurality of through-holes 116 that extend through each ridge of the plurality of ridges 112, from the support surface 114 to the lower surface 110 of the base 102. In other embodiments, the support tray 100 includes a plurality of through-holes 120 that extend through the base 102, from the upper surface 108 to the lower surface 110 in each groove of the plurality of grooves 118. Thus, it is contemplated that the support tray 100 includes either, both, or neither of the plurality of through-holes 116 of the plurality of ridges 112 and/or the plurality of through-holes 120 of the plurality of grooves 118.

Moreover, in some embodiments, such as those illustrated in FIGS. 1 and 2, the plurality of through-holes 116 of the plurality of ridges 112 and/or the plurality of through-holes 120 of the plurality of grooves 118 may extend over only a portion of the support tray 100. For example, the plurality of through-holes 116, 120 together form a pill-shaped pattern centered about axis X-X that extends between the first end 104 and the second end 106 of the base 102, but does not extend to the full width nor to the corners of the base 102. In this regard, the pill-shaped pattern of through-holes 116, 120 generally covers an area or footprint that is shaped similar to, but sized larger than, an area or footprint covered by the one or more green ceramic monoliths 101 that may be supported on the support tray 100. However, it should be understood that other shapes and patterns are contemplated and possible. For example, the plurality of through-holes 116 of the plurality of ridges 112 and/or the plurality of through-holes 120 of the plurality of grooves 118 may be formed in a pattern that extends over substantially all of the support tray 100, including the full width and length thereof. In other examples, the plurality of through-holes 116 and/or 120 may be formed in a pattern that at least extends over the area or footprint covered by the one or more green ceramic monoliths 101 that may be supported on the support tray 100.

In addition, in embodiments, such as embodiment illustrated FIGS. 1 and 2, the plurality of through-holes 116 of the plurality of ridges 112 and the plurality of through-holes 120 of the plurality of grooves 118 are arranged on each ridge and/or each groove in a single column of evenly spaced, evenly sized through-holes. However, other arrangements are contemplated. For example, the plurality of through-holes 116 and/or the plurality of through-holes 120 may be arranged in multiple columns and/or rows on each ridge and/or each groove. As another example, the spacing between each through-hole in the plurality of through-holes 116 and/or each through-hole in the plurality of through-holes 120 may vary on each ridge and/or each groove. In an additional example, the plurality of through-holes 116 and/or the plurality of through-holes 120 may vary in size. For example, the plurality of through-holes 116 may be larger or smaller than the plurality of through-holes 120.

By including the plurality of through-holes 116 in the plurality of ridges 112, localized ventilation is provided to the one or more green ceramic monoliths 101 supported on the support tray 100 as they undergo a drying process. That is, the plurality of through-holes 116 are provided to aid the flow of air through the plurality of ridges 112 to the one or more green ceramic monoliths 101 supported on the support surface 114, thereby improving the drying process of the one or more green ceramic monoliths 101. Moreover, while the plurality of grooves 118 already provide an open area through which air can flow to aid the drying process of the one or more green ceramic monoliths 101, the plurality of through-holes 120 can provide additional ventilation through the base 102 of the support tray 100. The drying efficiency of the support tray 100 can be tuned for green ceramic monoliths of different sizes and configurations (e.g., cell densities of the honeycomb structure) by varying the pattern of the plurality of through-holes 116 and/or the plurality of through-holes 120 that extends over the support tray 100 and by varying the arrangement of through-holes in each ridge and/or each groove of the plurality of ridges 112 and grooves 118, respectively.

In some embodiments, and with reference to FIGS. 1 and 3, the support tray 100 includes one or more protrusions 122 that extend outward from one or both sides of the base 102. As shown in FIG. 3, one or more protrusions 122 of one support tray 100A are adapted to engage or abut one or more protrusions of an adjacent support tray 100B when the support trays 100A, 100B are indexed next to one another in a processing line. For example, the processing line may be a drying process line where the support trays 100A, 100B are conveyed through a dryer to dry the one or more green ceramic monoliths (e.g., green ceramic monoliths 101) supported on the support trays 100A, 100B. In this regard, hot spots may form in the support trays 100A, 100B as the support trays 100A, 100B travel through the dryer. The engagement or abutment of the one or more protrusions 122 of adjacent support trays 100A, 100B helps minimize the surface contact area between the edges or sides of each base 102 of the support trays 100A, 100B. Minimizing the surface contact area between adjacent support trays 100A, 100B helps to minimize or eliminate hot spots between adjacent support trays 100A, 100B which might otherwise affect the drying process of the one or more green ceramic monoliths positioned thereon. Moreover, the one or more protrusions 122 help prevent damage to the base 102, plurality of ridges 112, and/or plurality of grooves 118 when one support tray (e.g., support tray 102A) comes into contact with another support tray (e.g., support tray 102B) in the processing line.

In embodiments, and as shown in FIGS. 2 and 6A, the support tray 100 includes one or more notches 124 formed in an outer sidewall of the one of the plurality of ridges 112 that is located adjacent to the first end 104 or the second end 106 of the base 102. A datum surface 126 is disposed in each of the one or more notches 124. Prior to the associated lifting apparatus transferring a green ceramic monolith to the support tray 100, precise alignment of the support tray 100 and the associated lifting apparatus is desired. In this regard, as discussed in further detail below, the datum surface 126 is used in conjunction with a measurement device to help ensure the precise alignment of support tray 100 and the associated lifting apparatus. Each of the one or more notches 124 provides a recess in which the datum surface 126 is positioned. Positioning the datum surface 126 in the notch 124 protects the datum surface 126 from damage that may occur during processing and, thus, preserves the integrity of the datum surface 126. As such, the precise alignment of the support tray 100 and the associated lifting apparatus can be maintained over the life of the support tray 100.

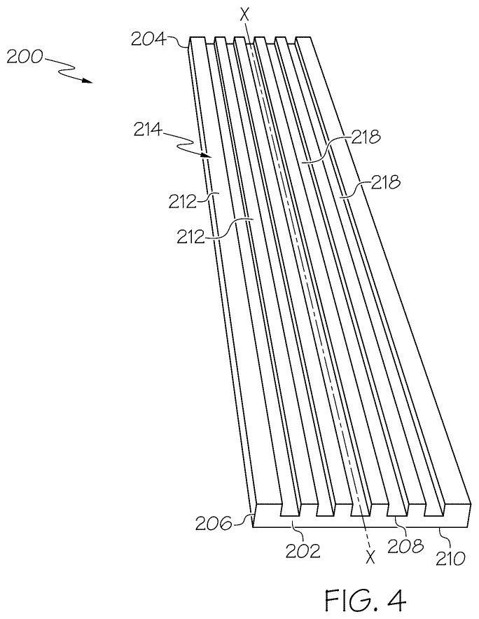

As mentioned above, other orientations of the plurality of ridges 112 and the plurality of grooves 118 with respect to the longitudinal axis X-X of the support tray 100 are contemplated and possible. In this regard, FIG. 4 illustrates a support tray 200 according to one or more embodiments described herein. Similar to the support tray 100 described above, the support tray 200 generally includes a base 202 that extends longitudinally along axis X-X between a first end 204 and a second end 206. The base 202 includes an upper surface 208 that is spaced apart from a lower surface 210. A plurality of ridges 212 extend upward from the upper surface 208 of the base 202 to define a support surface 214 that is parallel to the upper surface 208. In other words, a top surface of the plurality of ridges 212 forms the support surface 214 that is spaced apart from the upper surface 208. The support surface 214 is generally configured to support one or more green ceramic monoliths thereon. A plurality of grooves 218 extend downward from the support surface 214 to the upper surface 208 of the base 202. Each of the plurality of grooves 218 is spaced apart from an adjacent groove by one of the plurality of ridges 212. In other words, each groove of the plurality of grooves 218 is adjacent to a ridge of the plurality of ridges 212. The plurality of grooves 218 provide an open area through which air can flow to aid the drying process of one or more green ceramic monoliths supported on the support tray 200. Furthermore, while the plurality of ridges 212 and the plurality of grooves 218 are illustrated in FIG. 4 without a plurality of through-holes, it should be understood that, similar to support tray 100, a plurality of through-holes may be formed in each ridge of the plurality of ridges 212 and/or each groove of the plurality of grooves 218 of the support tray 200. Different from the support tray 100 described above, the plurality of ridges 212 and the plurality of grooves 218 extend across a length of the support tray 200 and are oriented parallel to the longitudinal axis X-X of the support tray 200.

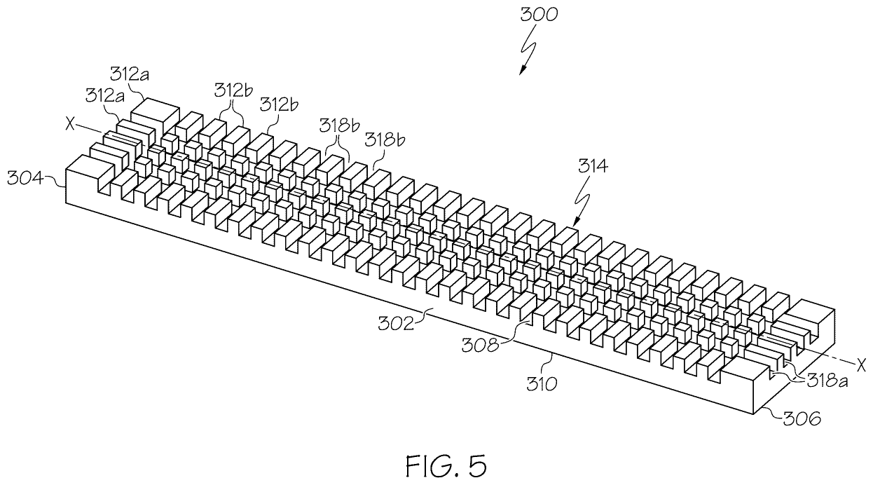

Referring now to FIG. 5, a support tray 300 is illustrated according to one or more embodiments described herein. The support tray 300 is configured such that one or more green ceramic monoliths may be indexed on the support tray 300 in a direction perpendicular or parallel to the non-vertical extrusion direction of the green ceramic monoliths. In other words, the support tray 300 may be used in a process line where the longitudinal axis X-X of the support tray 300 is oriented perpendicular or parallel to the non-vertical extrusion direction of the green ceramic monoliths. Similar to the support tray 100 described above, the support tray 300 generally includes a base 302 that extends longitudinally along axis X-X between a first end 304 and a second end 306. The base 302 includes an upper surface 308 that is spaced apart from a lower surface 310. Different from the support tray 100, support tray 300 includes a first plurality of ridges 312a and a second plurality of ridges 312b that both extend upward from the upper surface 308 of the base 302 to define a support surface 314 that is parallel to the upper surface 308. The support surface 314 is generally configured to support one or more green ceramic monoliths thereon. A first plurality of grooves 318a and a second plurality of grooves 318b both extend downward from the support surface 314 to the upper surface 308 of the base 302. Each of the first plurality of grooves 318a is spaced apart from an adjacent groove by one of the first plurality of ridges 312a. Each of the second plurality of grooves 318b is spaced apart from an adjacent groove by one of the second plurality of ridges 312b. The first and second plurality of grooves 318a, 318b provide an open area through which air can flow to aid the drying process of one or more green ceramic monoliths supported on the support tray 300. The first plurality of ridges 312a and the first plurality of grooves 318a extend across a length of the support tray 300 and are oriented parallel to the longitudinal axis X-X of the support tray 300. The second plurality of ridges 312b and the second plurality of grooves 318b extend across a width of the support tray 300 and are oriented perpendicular to the longitudinal axis X-X of the support tray 300. Furthermore, while the first and second plurality of ridges 312a, 312b and the first and second plurality of grooves 318a, 318b are illustrated in FIG. 5 without a plurality of through-holes, it should be understood that, similar to support tray 100, a plurality of through-holes may be formed in the each ridge of the first and second plurality of ridges 312a, 312b and/or each groove of the first and second plurality of grooves 318a, 318b of the support tray 300.

The support trays 100, 200, and 300 described above may generally be formed from a material that provides a high maximum operating temperature to withstand the heat of the drying process for the green ceramic monoliths and a high durability to permit repeated use of the support trays without excessive chipping or cracking. In embodiments, the support trays 100, 200, and 300 are formed from a ceramic material. In particular embodiments, the support trays 100, 200, and 300 are formed from a ceramic fiber board material. In embodiments, the ceramic fiber board material may be Kaowool® HS made commercially available by Morgan Advanced Materials. In other particular embodiments, the support trays 100, 200, and 300 are formed from a fiberglass laminate material. The fiberglass laminate material may be Garolite G10. In further particular embodiments, the support trays 100, 200, and 300 may be formed from a porous material with a porosity of greater than about 50% and an operating temperature of up to about 200° C. In embodiments, the porous material is a sintered metal. In other embodiments, the porous material is a porous cast aluminum made commercially available by ALUPOR™ or Exxentis Ltd. In additional embodiments, the porous material is a silicon carbide foam made commercially available by Ultramet or ERG Aerospace Corp. In further embodiments, the porous material is an aluminum foam, a copper foam, or a carbon foam made commercially available by ERG Aerospace Corp.

Referring now to FIG. 6A a system 400 for handling and/or conveying green ceramic monoliths is illustrated according to one or more embodiments described herein. The system 400 generally includes a lifting apparatus 402, a support tray 100 as described above, and an actuator 414 coupled to the lifting apparatus 402. The system 400 also generally includes a conveyor 436 for conveying the support tray 100 (and the green ceramic monolith 101 supported thereon) in a processing line. While the system 400 is illustrated as utilizing the support tray 100, it should be understood that the system 400 can also be adapted to utilize the support tray 200 or the support tray 300 described above. FIGS. 6B and 6C illustrate a portion of the lifting apparatus 402 in isolation from the system 400.

The lifting apparatus 402 is generally adapted to re-orient one or more green ceramic monoliths 101 from a non-vertical extrusion position (e.g., a position generally aligned with the extrusion direction 430) to the vertical position shown in FIG. 6A. In this regard, the lifting apparatus 402 is generally configurable between a non-vertical configuration (FIG. 6C) for receiving the one or more green ceramic monoliths 101 in a non-vertical orientation and a vertical configuration (FIGS. 6A and 6B) for re-orienting the one or more green ceramic monoliths to a vertical orientation. The support tray 100 is generally adapted to support the one or more green ceramic monoliths 101 in the vertical orientation as the one or more green ceramic monoliths 101 undergo a drying process.

As best seen in FIGS. 6B and 6C, the lifting apparatus 402 may generally include a body 404 which extends between a first end 406 and a second end 408. A receiving cradle 410 may be formed in the body 404 of the lifting apparatus 402 that is configured to receive and support the green ceramic monolith 101 during the re-orientation process thereof. The receiving cradle 410 is generally sized and shaped to correspond to an outer periphery (e.g., sidewall) of the green ceramic monolith 101. For example, the receiving cradle 410 may be a concave cylindrical surface to match the outer periphery shape and size of the green ceramic monolith. Furthermore, a plurality of support prongs 412 extend from the first end 406 of the body 404 and the plurality of support prongs 412 are configured to support the green ceramic monolith 101 thereon. In some embodiments, the plurality of support prongs 412 include at least two support prongs that extend from the first end 406 of the body 404. The at least two support prongs may be configured to support the green ceramic monolith 101 thereon. With reference to FIG. 7, each support prong of the plurality of support prongs 412 has a prong height H_{P} and a prong width W_{P}. The prong height H_{P} of each of the plurality of support prongs 412 is less than the groove height H_{G} of each of the plurality of grooves 118. In addition, the prong width W_{P} of each of the plurality of support prongs 412 is less than the groove width W_{G} of each of the plurality of grooves. In embodiments, the dimensions of the support prongs 412 relative to the plurality of grooves 118 aids in engaging the support prongs 412 with the plurality of grooves 118 to position a green ceramic monolith 101 on a support tray and, thereafter, withdrawing the support prongs 412 from the plurality of grooves 118 without damaging an end face of the green ceramic monolith 101.

Referring again to FIG. 6A, the lifting apparatus 402 may generally further include an actuator 414 coupled to the body 404 of the lifting apparatus 402. The actuator 414 is operable to manipulate the body 404 of the lifting apparatus 402 between the non-vertical configuration (FIG. 6C) and the vertical configuration (FIG. 6B). In other words, the lifting apparatus 402 is pivotable between the non-vertical configuration shown in FIG. 6C and the vertical configuration shown in FIG. 6B. When the lifting apparatus 402 is in the non-vertical configuration, the first end 406 of the body 404 of the lifting apparatus 402 is positioned above the support surface 114 of the support tray 100 such that the plurality of support prongs 412 extend upward in a direction generally perpendicular to the support surface 114. When the lifting apparatus 402 is pivoted into the vertical configuration, the first end 406 of the body 404 of the lifting apparatus 402 is positioned adjacent to the support surface 114 of the support tray 100 such that the plurality of support prongs 412 are received within the plurality of grooves 118 of the support tray 100 and the plurality of support prongs 412 are positioned below the support surface 114 of the plurality of ridges 112. In this manner, support of the green ceramic monolith 101 can be transferred from the plurality of support prongs 412 to the support surface 114 of the plurality of ridges 112.

More particularly, the actuator 414 is operable to manipulate the body 404 of the lifting apparatus 402 to engage the plurality of support prongs 412 of the body 404 with the plurality of grooves 118 of the support tray 100. The actuator 414 is further operable to disengage the plurality of support prongs 412 of the body 404 from the plurality of grooves 118 of the support tray 100 and thereby transfer support of the green ceramic monolith 101 from the plurality of support prongs 412 of the body 404 of the lifting apparatus 402 to the support surface 114 of the plurality of ridges 112. Moreover, the actuator 414 is operable to at least raise and lower the body 404 of the lifting apparatus 402 relative to the support tray 100 and/or pivot the body 404 of the lifting apparatus 402 relative to the support tray 100 about an axis R-R that is parallel to the support surface 114 of the plurality of ridges 112.

In the embodiments described herein, a clearance is generally provided between each side of the plurality of support prongs 412 and each side of the plurality of grooves 118 when the lifting apparatus 402 is in the vertical configuration and the plurality of support prongs 412 are received within the plurality of grooves 118. In some embodiments, the clearance between each side of the plurality of support prongs 412 and each side of the plurality of grooves 118 is between greater than or equal to 0.020″ (0.508 mm) and less than or equal to 0.040″ (1.016 mm).

In embodiments of the system 400 illustrated in FIG. 6A, the support tray 100 is set on a processing line that utilizes the lifting apparatus 402 to index the one or more green ceramic monoliths 101 on the support tray 100 in a conveying direction 432 that is generally perpendicular to a non-vertical extrusion direction 430 of the one or more green ceramic monoliths. That is, the support tray 100 may be positioned on a conveyor 436, such as a conveyor belt, roller table, or the like, which facilitates conveying the support tray in the conveying direction 432. In this embodiment, the plurality of ridges 112 and the plurality of grooves 118 are aligned along the short-axis of the support tray 100. As such, when it is desired to move or index the support tray 100 in the conveying direction 432 to receive a subsequent green ceramic monolith, the plurality of support prongs 412 is fully retracted from the plurality of grooves 118 to allow the support tray 100 to index to the next place position for receiving the subsequent green ceramic monolith.

In accordance with other embodiments, in the system 400 illustrated in FIG. 6A, the support tray 200 or the support tray 300 as described above can be used. The support tray 200 or the support tray 300 are set on a processing line that utilizes the lifting apparatus 402 to index the one or more green ceramic monoliths 101 on the support tray 200 or the support tray 300 in a conveying direction that is generally parallel to the non-vertical extrusion direction 430 of the one or more green ceramic monoliths. Moreover, when the support tray 200 is used, the plurality of ridges 212 and the plurality of grooves 218 are aligned along the longitudinal axis of the support tray 200. As such, when it is desired to move the support tray 200 in the parallel conveying direction to receive a subsequent green ceramic monolith, the plurality of support prongs 412 can start to retract from the plurality of grooves 218 simultaneous to the support tray 200 indexing to the next place position for receiving the subsequent green ceramic monolith. Similarly, when the support tray 300 is used, the first plurality of ridges 312a and the first plurality of grooves 318a are aligned along the longitudinal axis of the support tray 300. As such, when it is desired to move the support tray 300 in the parallel conveying direction to receive a subsequent green ceramic monolith, the plurality of support prongs 412 can start to retract from the first plurality of grooves 318a simultaneous to the support tray 300 indexing to the next place position for receiving the subsequent green ceramic monolith.

To ensure that the support tray 100 of system 400 is properly indexed to the next place position for receiving a subsequent green ceramic monolith from the lifting apparatus 402, one or more flat datum surfaces 126 is utilized in conjunction with one or more measurement devices 420, 424 to track the location of the support tray 100 with respect to the lifting apparatus 402. In some embodiments, the one or more measurement devices 420, 424 are lasers that emit respective beams 422 and 426 toward the one or more datum surfaces 126 to precisely track the edges or sides of the support tray 100 as the support tray 100 is indexed between indexing positions. By precisely tracking this movement, the one or more measurement devices 420, 424 can be used for feedback control of the movement of the support tray 100 (i.e., used for feedback control of the conveyor on which the support tray 100 is positioned) once the support tray 100 has reached the next place indexing position, such that the plurality of support prongs 412 of the lifting apparatus 402 can properly engage the plurality of grooves 118 of the support tray 100 and transfer support of the subsequent green ceramic monolith from the plurality of support prongs 412 to the support surface 114 of the support tray 100 at the next place indexing position. The one or more notches 124 in which the datum surface 126 is disposed helps protect the datum surface 126 from contact with other components that might damage the datum surface 126. In this regard, the one or more measurement devices 420, 424 can continue to reliably track the position of the support tray 100 with respect to the lifting apparatus 402 over the life of the support tray 100.

It is to be appreciated that, based on the embodiments described above, a method for conveying a green ceramic monolith is described in the present disclosure. In particular, the method includes receiving the green ceramic monolith on a lifting apparatus (e.g., lifting apparatus 402), and the lifting apparatus includes a body (e.g., body 404), at least two support prongs (e.g., plurality of support prongs 412) extending from the body, and an actuator (e.g., actuator 414) coupled to the body, where the at least two support prongs are configured to support the green ceramic monolith thereon. In embodiments, the green ceramic monolith is received on the lifting apparatus in a non-vertical orientation. The method further includes aligning a support tray (e.g., support tray 100) with the lifting apparatus 402, the support tray comprising a base (e.g., base 102), a plurality of ridges (e.g., plurality of ridges 112) extending upward from the base to define a support surface (e.g., support surface 114), and a plurality of grooves (e.g., plurality of grooves 118), wherein each of the plurality of grooves is spaced apart from an adjacent groove by one of the plurality of ridges. The method additionally includes engaging the at least two support prongs of the body of the lifting apparatus with the plurality of grooves of the support tray such that the green ceramic monolith is supported on the support surface of the support tray. In embodiments, the engaging includes manipulating the body of the lifting apparatus with the actuator to re-orient the green ceramic monolith from the non-vertical orientation to a vertical orientation. The method then includes conveying the green ceramic monolith on the support tray for further processing. In some embodiments, the conveying disengages the at least two support prongs of the body of the lifting apparatus from the plurality of grooves of the support tray.

From the above, it is to be appreciated that defined herein are systems, methods, and apparatuses (e.g., support trays) that provide for the orientation of green ceramic monoliths from a non-vertical extrusion position to a vertical position to improve processing of the green ceramic monoliths during a drying process thereof. The system generally includes a lifting apparatus for orienting the green ceramic monoliths into the vertical orientation and a support tray for supporting the green ceramic monoliths in the vertical orientation as the green ceramic monoliths undergo the drying process. The lifting apparatus is configured to engage the support tray in such a manner that support of the green ceramic monolith can be transferred from a plurality of support prongs of the lifting apparatus to a support surface of the support tray. The support tray is configured with one or more ventilation features which aid the drying process of the green ceramic monoliths.

Referring now to FIG. 8, it should be understood that the system 400, which generally includes the lifting apparatus 402, a support tray 100, actuator 414, and conveyor 436 as described above, may be incorporated as part of an overall system or processing line 500 for processing a plurality of green ceramic monoliths (e.g., green ceramic monoliths 501a-501c). The processing line 500 begins with an extruder 510 that generally extrudes a wet ceramic batch through a die to form a non-vertically oriented extrusion 501 (i.e., the long-axis of the extrusion 501 is not oriented in a vertical direction). A portion of the non-vertical extrusion 501 is cut to a desired length to form one or more green ceramic monoliths 501a-501c. The green ceramic monoliths 501a-501c exiting the extruder 510 are supported and lifted and/or pivoted from the non-vertical position to a vertical position by the lifting apparatus 402. The lifting apparatus 402 transfers support of the green ceramic monoliths 501a-501c to a plurality of support trays 100A-100C such that the green ceramic monoliths 501a-501c are supported on the plurality of support trays 100A-100C in the vertical position. The plurality of support trays 100A-100C may enter the processing line 500 adjacent to the lifting apparatus such that the green ceramic monoliths may be indexed on the support trays in a direction perpendicular or parallel to the non-vertical extrusion direction of the extrusion 501. Once a support tray (e.g., one of 100A-100C) has been loaded with a desired amount (e.g., 3 or more) of green ceramic monoliths (e.g., 501a-501c), the plurality of support trays 100A-100C and green ceramic monoliths 501a-501c supported thereon are conveyed via conveyor 436 to a dryer 520, where the green ceramic monoliths 501a-501c are dried to reduce or remove water content from the green ceramic material. The plurality of support trays 100A-100C and now dried green ceramic monoliths 501a-501c supported thereon are then conveyed via conveyor 436 to a kiln 530, where the green ceramic monoliths are fired at specified temperatures in a given atmosphere to sinter the direct green ceramic monoliths into ceramic monoliths.

While the system or processing line 500 of FIG. 8 is illustrated as including specific processing steps of extruding at extruder 510, drying at dryer 520, and firing at kiln 530, it should be understood that other process steps may be included without departing from the scope of the present disclosure. Moreover, while the processing line 500 of FIG. illustrates a single conveyor 436, it should be understood that multiple conveyors may be utilized to appropriately convey the green ceramic monoliths 501a-501c in multiple directions as necessary.

It will be apparent to those skilled in the art that various modifications and variations can be made to the embodiments described herein without departing from the scope of the claimed subject matter. Thus, it is intended that the specification cover the modifications and variations of the various embodiments described herein provided such modification and variations come within the scope of the appended claims and their equivalents.

What is claimed is:

1. A system for handling green ceramic monoliths, the system comprising:
a lifting apparatus comprising a body and at least two support prongs that extend from the body, each of the at least two support prongs comprising a prong length L_{P}, a prong width W_{P}, and a prong height H_{P}, the at least two support prongs configured to support a green ceramic monolith thereon;
a support tray that receives the green ceramic monolith from the lifting apparatus, the support tray comprising:
a base extending longitudinally between a first end and a second end and comprising an upper surface spaced apart from a lower surface;
a plurality of ridges extending upward from the upper surface of the base, the plurality of ridges defining a support surface parallel to the upper surface of the base; and
a plurality of grooves extending downward from the support surface to the upper surface of the base, each groove of the plurality of grooves comprising a groove length L_{G}, a groove width W_{G}, and a groove height H_{G}, wherein each groove of the plurality of grooves is spaced apart from an adjacent groove by one of the plurality of ridges; and
an actuator coupled to the body of the lifting apparatus, wherein:
the prong height H_{P} of each of the at least two support prongs is less than the groove height H_{G} of each groove of the plurality of grooves;
the prong width W_{P} of each of the at least two support prongs is less than the groove width W_{G} of each groove of the plurality of grooves; and
the actuator is operable to manipulate the body of the lifting apparatus to engage the at least two support prongs of the body with the plurality of grooves of the support tray and disengage the at least two support prongs of the body from the plurality of grooves of the support tray and thereby transfer support of the green ceramic monolith from the at least two support prongs of the body of the lifting apparatus to the support surface of the plurality of ridges.

2. The system of claim 1, wherein the actuator is operable to at least one of:
raise and lower the body of the lifting apparatus relative to the support tray; or
pivot the body of the lifting apparatus relative to the support tray about an axis parallel to the support surface of the plurality of ridges.

3. The system of claim 1, wherein the support tray comprises a plurality of through-holes extending through each of the plurality of ridges from the support surface to the lower surface of the base.

4. The system of claim 1, wherein the support tray comprises a plurality of through-holes extending through the base from the upper surface to the lower surface in each of the plurality of grooves.

5. The system of claim 1, wherein the support tray comprises a ceramic material.

6. The system of claim 1, wherein the plurality of ridges and the plurality of grooves extend across a width of the support tray and are oriented perpendicular to a longitudinal axis of the support tray.

7. The system of claim 1, wherein the plurality of ridges and the plurality of grooves extend across a length of the support tray and are oriented parallel to a longitudinal axis of the support tray.

8. The system of claim 1, wherein the support tray comprises one or more protrusions extending outward from sides of the base of the support tray.

9. The system of claim 1, wherein:
the support tray comprises one or more notches formed in an outer sidewall of one of the plurality of ridges located adjacent to the first end or second end of the base; and
a datum surface disposed in each of the one or more notches.

10. A system for conveying a green ceramic monolith, comprising:
a lifting apparatus comprising a body and a plurality of support prongs extending from the body, wherein the lifting apparatus is pivotable between a non-vertical configuration for receiving the green ceramic monolith in a non-vertical orientation and a vertical configuration for re-orienting the green ceramic monolith to a vertical orientation;
a support tray for supporting the green ceramic monolith in the vertical orientation, the support tray comprising:
a base extending longitudinally between a first end and a second end and comprising an upper surface spaced apart from a lower surface;
a plurality of ridges disposed between the first end and the second end of the base and extending upward from the upper surface of the base, the plurality of ridges defining a support surface, each ridge of the plurality of ridges comprising a plurality of through-holes extending between the support surface and the lower surface of the base; and
a plurality of grooves disposed between the first end and the second end of the base and extending downward from the support surface to the upper surface of the base, each groove of the plurality of grooves comprising a plurality of through-holes extending between the upper surface and the lower surface of the base, wherein each groove of the plurality of grooves is adjacent to a ridge of the plurality of ridges, wherein, when the lifting apparatus is in the vertical configuration, the plurality of support prongs are received within the plurality of grooves of the support tray and positioned below the support surface of the plurality of ridges.

11. The system of claim 10, wherein the plurality of grooves of the support tray have a groove height H_{G} and the plurality of support prongs of the lifting apparatus have a prong height H_{P}, wherein the groove height H_{G} is greater than the prong height H_{P}.

12. The system of claim 10, wherein the plurality of grooves of the support tray have a groove width W_{G} and the plurality of support prongs of the lifting apparatus have a prong width W_{P}, wherein the groove width W_{G} is greater than the prong width W_{P}.

13. The system of claim 10, further comprising a clearance of greater than or equal to 0.020 inches (0.508 mm) to less than or equal to 0.040 inches (1.016 mm) between each side of the plurality of support prongs and each side of the plurality of grooves when the lifting apparatus is in the vertical configuration and the plurality of support prongs are received within the plurality of grooves.

14. The system of claim 10, further comprising a receiving cradle formed in the body of the lifting apparatus, the receiving cradle configured to receive the green ceramic monolith.

15. The system of claim 10, wherein the plurality of ridges and the plurality of grooves extend across a width of the support tray and are oriented perpendicular to a longitudinal axis of the support tray.

16. The system of claim 10, wherein the plurality of ridges and the plurality of grooves extend across a length of the support tray and are oriented parallel to a longitudinal axis of the support tray.

17. A method for conveying a green ceramic monolith, comprising:
receiving the green ceramic monolith on a lifting apparatus, the lifting apparatus comprising a body, at least two support prongs extending from the body, and an actuator coupled to the body, the at least two support prongs configured to support the green ceramic monolith thereon;
aligning a support tray with the lifting apparatus, the support tray comprising a base, a plurality of ridges extending upward from the base to define a support surface, and a plurality of grooves, wherein each groove of the plurality of grooves is spaced apart from an adjacent groove by one of the plurality of ridges;
engaging the at least two support prongs of the body of the lifting apparatus with the plurality of grooves of the support tray such that the green ceramic monolith is supported on the support surface of the support tray; and
conveying the green ceramic monolith on the support tray for further processing.

18. The method of claim 17, wherein:
the green ceramic monolith is received on the lifting apparatus in a non-vertical orientation; and
the engaging comprises manipulating the body of the lifting apparatus with the actuator to reorient the green ceramic monolith from the non-vertical orientation to a vertical orientation.

19. The method of claim 17, wherein the conveying disengages the at least two support prongs of the body of the lifting apparatus from the plurality of grooves of the support tray.
